(19) United States
(12) Patent Application Publication
(10) Pub. No.: US 2010/0146305 A1
(43) Pub. Date: Jun. 10, 2010

(54) Electronic Apparatus and Method of Controlling the Same

(75) Inventor: Kyoichi KAMIJIMA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/571,906

(22) Filed: Oct. 1, 2009

(30) Foreign Application Priority Data
Dec. 8, 2008 (JP) 2008-311962

(51) Int. Cl. G06F 1/26

(52) U.S. Cl. 713/300

(57) ABSTRACT

An electronic apparatus that selectively performs one of a plurality of operation modes including a first mode and a power saving mode with lower power consumption than the first mode, includes: a memory unit that stores data; a power unit that is supplied with power; and a control unit that stores in the memory unit the operation mode at the time at which supply of power to the power unit is stopped, and when the supply of power to the power unit is started, reads the operation mode stored in the memory unit and starts operation in the read operation mode.

### BACKGROUND

1. Technical Field

The present invention relates to an electronic apparatus and a method of controlling the same.

2. Related Art

In the past, an electronic apparatus is proposed which keeps track of the time after a power source is turned on, and when the time being tracked reaches a power supplying time set in advance, starts supplying power to a heater of a fixing unit, thereby distributing power consumed when the power source is turned on (for example, refer to JP-A-2000-19887).

However, in the electronic apparatus disclosed in JP-A-2000-19887, in some cases, the supply of power to the heater is started when the power supplying time elapses even in the case where the apparatus is not used for a while after starting operation, so that a further reduction in power consumption was not considered. In addition, there is a case where the power supplying time was set in advance. However, this case does not consider the frequency of use of the apparatus.

### SUMMARY

An advantage of some aspects of the invention is that it provides an electronic apparatus capable of further suppressing power consumption and using a mode with a higher frequency of use earlier, and a method of controlling the same.

According to an aspect of the invention, there is provided an electronic apparatus that selectively performs one of a plurality of operation modes including a first mode and a power saving mode with lower power consumption than the first mode, including: a memory unit that stores data; a power unit that is supplied with power from an external power source; and a control unit that stores in the memory unit the operation mode at the time at which the supply of power from the external power source to the power unit is stopped, and when the supply of power to the power unit is started, reads the operation mode stored in the memory unit and starts operation in the read operation mode.

In the electronic apparatus, one of the plurality of operation modes including the first mode and the power saving mode with lower power consumption than the first mode is selectively performed, the operation mode at the time at which the supply of power from the external power source is stopped is stored, the stored operation mode is read when the supply of power is started, and the apparatus starts operation, in the read operation mode. Here, it is thought that when the operation mode performed at the time at which the supply of power is stopped is the power saving mode, there is a tendency that the frequency of use of the electronic apparatus is low, and when the operation mode performed at the time at which the supply of power is stopped is the mode with higher power consumption than the power saving mode, there is a tendency that the frequency of use of the electronic apparatus is high. Here, when the supply of power is started, the apparatus starts operation in the operation mode at the time at which the electronic apparatus is stopped, which reflects the frequency of use of the electronic device. Therefore, power consumption can be suppressed, and the mode with a higher frequency of use can be used earlier.

In the electronic apparatus, the control unit may store in the memory unit the operation mode at the time at which the supply of power is stopped by storing in the memory unit the operation mode that is performed after switching the operation mode of the electronic apparatus from another mode to the power saving mode, or, from the power saving mode to another mode. Accordingly, for example, even in the case where the power supplied is suddenly cut off, the operation mode is stored in advance at the time of switching the operation mode. Therefore, power consumption can be more reliably suppressed, and the mode with higher frequency of use can be used earlier. Here, the “first mode” may be a predetermined process execution mode performed when a predetermined process is executed.

In the electronic apparatus, the control unit may determine whether or not the time elapsed from the time of termination of the previous operation has passed a predetermined time when the supply of power from the power unit is started, start operation in the power saving mode when the elapsed time passes the predetermined time, and read the operation mode stored in the memory unit when the elapsed time has not passed the predetermined time and then start operation in the read operation mode. Accordingly, when the elapsed time has not passed the predetermined time (for example, the elapsed time is relatively short such as in the case of a power failure), the apparatus starts operation in the state where the supply of power is stopped, so that the mode with higher frequency of use can be used earlier. In addition, when the elapsed time passes the predetermined time (for example, the elapsed time is relatively long), the apparatus starts operation in the power saving mode, so that power consumption can further be suppressed. Here, the “predetermined time” can be determined according to the application of the electronic apparatus, and for example, may be a time (for example, 10 minutes or the like) to detect a momentary power failure, or a time (for example, 10 hours or the like) to detect the start of operation at the time of starting operation every day.

In the electronic apparatus, the power unit may include a power maintaining unit that maintains power when the power supplied from an external power source is blocked, and the control unit may be supplied with power from the power maintaining unit when the power supplied from the external power source is cut off, and store the operation mode in the memory unit. Accordingly, power can be ensured by the power maintaining unit, so that the operation mode at the time when the supply of power is stopped can be more reliably stored, and power consumption can be more reliably suppressed. Moreover, the mode with higher frequency of use can be used earlier.

In the electronic apparatus, a printing process unit that is supplied with power from the power unit and prints an image on a printing medium may be included, and the control unit may control the printing process unit to perform the printing process. Although there is a high demand for the electronic apparatus that performs a printing process to suppress power consumption, the frequency of use immediately after the start of operation is different, so that applying the invention to the apparatus has great significance.

According to another aspect of the invention, there is provided a method of controlling an electronic apparatus that includes a memory unit for storing data and selectively performs one of a plurality of operation modes including a first mode and a power saving mode with lower power consumption than the first mode, the method including: storing in the memory unit the operation mode at the time at which the supply of power from the external power source is stopped; and reading the operation mode stored in the memory unit when the supply of power from the external power source is started, and starting operation in the read operation mode.

In the method of controlling an electronic apparatus, as in the electronic apparatus, when the supply of power is started, the electronic apparatus starts operation in the operation mode at the time at which the electronic apparatus is stopped, which reflects the frequency of use of the electronic apparatus, so that power consumption can further be suppressed, and the mode with higher frequency of use can be used earlier. In addition, in the method of controlling this electronic apparatus, various embodiments of the electronic apparatus described above may be employed. In addition, processes for implementing each function of the electronic apparatus described above may be added.

A program of the invention can be used for implementing each step of the above-mentioned method of controlling an electronic apparatus in one or plural computers. The program or programs may be recorded in computer readable recording media (for example, hard disks, ROMs, FDs, CDs, DVDs, and the like), delivered from computers to computers via transmission media (communication networks such as the Internet and LANs), or transceived in any form. When the program is executed in a single computer or the steps are split to be shared and executed by plural computers, each step of the above-mentioned method of controlling an electronic apparatus is executed, so that the same effects as those of this controlling method can be obtained.

### BRIEF DESCRIPTION OF THE DRAWINGS

The invention will be described with reference to the accompanying drawings, wherein like numbers reference like elements.

FIG. 1 is a diagram schematically illustrating the configuration of a network system.

FIG. 2 is a flowchart of an example of a printing process routine.

FIG. 3 is a flowchart of another example of the printing process routine.

FIG. 4 is a flowchart of another example of the printing process routine.

### DESCRIPTION OF EXEMPLARY EMBODIMENTS

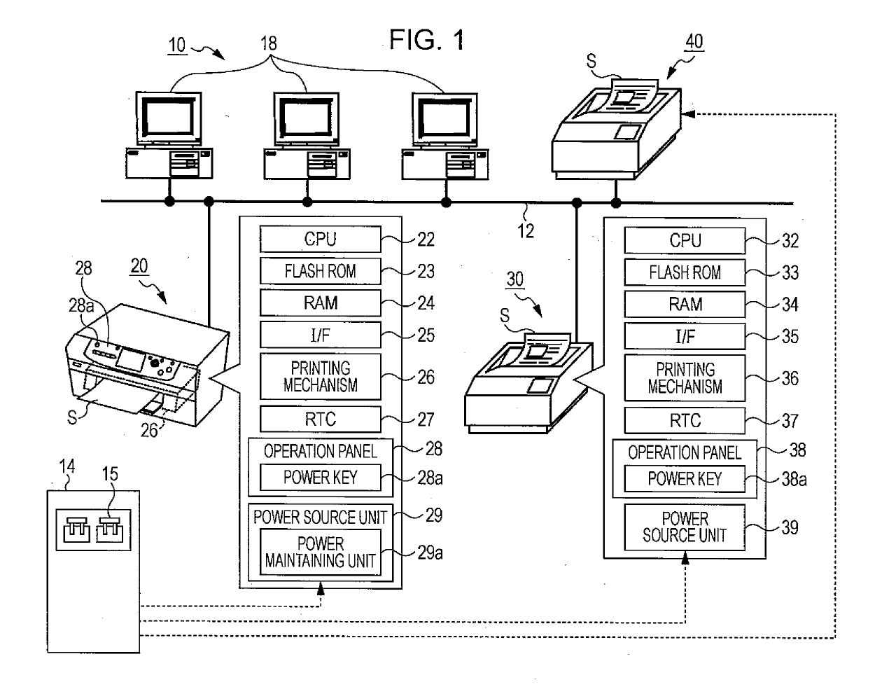

Hereinafter, exemplary embodiments of the invention will be described in detail with reference to the accompanying drawings. FIG. 1 is a diagram schematically illustrating the configuration of a network system 10 according to an embodiment of the invention. The network system 10 according to the embodiment includes printers 20, 30, and 40 connected to a LAN 12 as a network, and a plurality of user personal computers (hereinafter, referred to as user PCs) 18 connected via the LAN 12. The printers 20, 30, and 40 or the plurality of user PCs 18 are supplied with power through a distribution board 14 and a breaker 15. Here, in this network system 10, three printers and three user PCs are illustrated, however, arbitrary numbers of printers or user PCs may be included.

The user PC 18 is a well-known general PC configured as an information processing apparatus for users, and transmits printing work to the printer 20, the printer 30, or the like through installed programs or receives status information from the printer 20, the printer 30, or the like. The user PC 18 is provided with a display device for displaying various types of information on a screen, an input device such as a keyboard through which the user inputs various commands, and the like, and has a function of, when an operator inputs a command through the input device, a cursor, or the like displayed on the display device, performing operations according to the input command.

The printer 20 is an apparatus that prints an image on a recording sheet S on the basis of the printing work received via the LAN 12, and includes a CPU 22 in charge of controlling the entire apparatus, a flash ROM 23 that stores various processing programs and can rewrite data, a RAM 24 that temporarily stores data, and a network interface (I/F) 25 which can transceive signals with external devices connected to the LAN 12. The CPU 22, the flash ROM 23, and the RAM 24 constitute a controller. The controller of the printer 20 is configured to selectively perform one of the operation modes including a printing process execution mode for immediately performing the printing process and a power saving mode with lower power consumption than the printing process execution mode. The flash ROM 23 stores information at the time of termination about the operation mode and the time at the time of termination of the previous operation. In addition, the printer 20 includes a printing mechanism 26 for printing an image on the recording sheet S by ejecting an ink as a colorant, a real-time clock (RTC) 27 that keeps track of the current time, an operation panel 28 that can display information for the operator and through which the operator can input a command, and a power source unit 29 that supplies power received from an external commercial AC power source (external power source) via the distribution board 14 to the entire apparatus. The printing mechanism 26 is an inkjet-type mechanism for pressurizing ink in an ink-cartridge using a piezoelectric element or a heater provided in a print head to be ejected toward the recording sheet S. The operation panel 28 is provided with a power key 28a that is held down in the case where power is turned on or turned off. The power key 28a is electrically connected to the controller and the power source unit 29 and outputs a signal to the controller or the power source unit 29 when it is held down by the operator. The power source unit 29 has functions of converting the input AC into DC, cutting the power input from the commercial AC power source, and maintaining voltage by a power maintaining unit 29a for a short predetermined time (a few seconds) when the supply of power has a problem such as a power failure. The power maintaining unit 29a may be a rechargeable battery or a condenser. In addition, the power source unit 29 is connected to a power monitoring unit (not shown), and when the input voltage is lower than a predetermined threshold, the power monitoring unit outputs a signal indicating a problem with the supply of power to the controller.

The printer 30 is an apparatus that prints an image on the printing sheet S on the basis of the printing work received via the LAN 12, and includes a CPU 32 in charge of controlling the entire apparatus, a flash ROM 33 which stores various processing programs and can rewrite data, a RAM 34 that temporarily stores data, and an I/F 35 that can transceive signals with external devices connected to the LAN 12. The CPU 32, the flash ROM 33, and the RAM 34 constitute a controller. The controller of the printer 30 is configured to selectively perform one of operation modes including a printing process execution mode for immediately performing the printing process and a power saving mode with lower power consumption than the printing process execution mode. The flash ROM 33 stores information at the time of termination about the operation mode and the time at the time of termination of the previous operation. In addition, the printer 30 includes a printing mechanism 36 for printing an image on the recording sheet S using toner as a colorant, a real-time clock (RTC) 37 that keeps track of the current time, an operation panel 38 that can display information for the operator and through which the operator can input a command, and a power source unit 39 that supplies power received from an external commercial AC power source (external power source) via the distribution board 14 to the entire apparatus. The printing mechanism 36 is configured as a full-color electrophotographic type printing mechanism, which employs a single photoreceptor type and an intermediate transfer type. In this type, printing is performed by developing an electrostatic latent image formed on a photoreceptor by adhering toner as a developer thereon, transferring this onto a recording medium (recording sheet S), and heating and pressurizing the toner transferred on the printing medium so as to allow the toner to be fused and fixed thereon. The operation panel 38 is provided with a power key 38a that is held down according to whether power is turned on or turned off. This power key 38a is connected electrically to the controller and the power source unit 39, and is configured to output a signal to the controller or the power source unit 39 in the case where it is held down by the operator. The power source unit 39 has functions of converting input AC into DC and cutting the power input from a commercial AC power source, without a power monitoring unit or a power maintaining unit. The printer 40 has the same configuration as the printer 30, so that a detailed description thereof will be omitted.

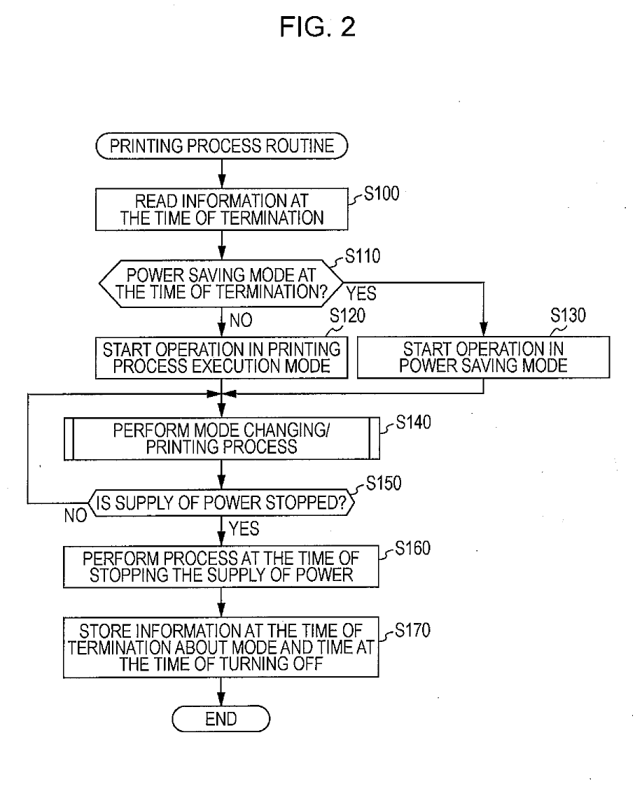

Next, the operations of the network system 10 having the above-mentioned configuration according to the embodiment, which are performed until the printer 20 is turned off after it is turned on, will be described. FIG. 2 is a flowchart of an example of a printing process routine executed by the CPU 22 of the printer 20. This routine is stored in the flash ROM 23 and is executed after the power key 28a of the operation panel 28 is held down and power is turned on.

When the routine is executed, the CPU 22 reads information at the time of termination of a previous operation from the flash ROM 23 (Step S100). In the information at the time of termination, information on the time of termination of the previous operation of the printer 20 and the operation mode (the printing process execution mode or the power saving mode) at that time is included. Here, the time of termination of the printer 20 includes the general time of termination at which the power key 28a is held down, and the times of termination at which problems with the supply of power occur, such as, a power failure occurs, the apparatus is unplugged, and the breaker 15 is cut. Next, the CPU 22 determines whether or not the mode at the time of termination of the previous operation is the power saving mode (Step S110), executes a process for starting operation in the printing process execution mode when the mode at the time of termination of the previous operation is not the power saving mode (Step S120), and executes a process of starting operation also in the power saving mode when the mode at the time of termination of the previous operation is the power saving mode (Step S130). Here, starting operation in the printing process execution mode refers to operating in a state where the printing process can be immediately performed, for example, performing an initial process such as a cleaning process of a print head (not shown) or flushing process, or allowing the I/F 25 to start operation in a normal state while waiting for printing work. On the other hand, starting operation in the power saving mode refers to not performing the initial process, or starting operation where the operation of the I/F 25 is excluded. As described above, at the time of starting the power supply, the apparatus starts operation in the operation mode at the time of termination of the previous operation, which reflects the frequency of use of the printer 20.

After Steps S120 and S130, the CPU 22 executes a mode changing/printing process (Step S140). In the mode changing/printing process, for example, when a predetermined power saving switching condition is satisfied, a process of switching from the printing process execution mode to the power saving mode is performed, or when a predetermined normal switching condition is satisfied, a process of switching from the power saving mode to the printing process execution mode is performed. In the power saving switching condition, for example, a condition of passing a predetermined time (five minutes or the like) without receiving printing work, or the like, is included. In the normal switching condition, for example, a condition of receiving printing work or the operation panel 28 being operated is included. In addition, in the mode changing/printing process, when the printing work is received, a process of printing an image on a recording sheet S with colorants using image data stored in the printing work is performed.

After Steps S140, the CPU 22 determines whether or not the supply of power is stopped (Step S150), and when the supply of power is not stopped, the process of Step S140 repeatedly performed. Here, the determination that the supply of power is stopped is made on the basis of whether or not a signal indicating a problem with the supply of power is received from the power source unit 29, or whether or not the power key 28a of the operation panel 28 is held down. In Step S150, when the supply of power is stopped, a process at the time of stopping the supply of power, such as, storing information (an amount of ink consumed or the like) on the printer in the flash ROM 23 is performed (Step S160), the information at the time of termination about the operation time at this time point and the time is stored in the flash ROM 23 (Step S170), and then the routine is terminated. In addition, in the printer 20, in the case of the problem with the supply of power, the power is ensured for a predetermined time to complete the process of storing the information at the time of termination by the power maintaining unit 29a. As described above, for example, in the case where power is turned on to start operation or turned off at the time of terminating the operation by the breaker 15, the printer 20 starts operation in the state of the previous operation, so that it starts operation in the power saving mode when the frequency of use is low and starts operation in the printing process execution mode when the frequency of use is high.

Here, the correlation between components of this embodiment and components of the invention will be clarified. The flash ROM 23 of this embodiment corresponds to the memory unit of the invention, the power source unit 29 corresponds to the power unit, the CPU 22 corresponds to the controller, the power maintaining unit 29a corresponds to the power maintaining unit, the printing mechanism 26 corresponds to the printing process unit, and the recording sheet S corresponds to the printing medium. In addition, in this embodiment, an example of the method of controlling an electronic apparatus of the invention is clarified by describing the operations of the printer 20.

The printer 20 described above in detail according to the embodiment, selectively performs one of the printing process execution mode and the power saving mode, stores the operation mode at the time at which the supply of power from an external power source is stopped in the flash ROM 23, reads the stored operation mode when the supply of power is started, and starts operation in the read operation mode. Here, when the supply of power is started, since the printer 20 starts operation in the operation mode at the time of stopping, which reflects the frequency of use of the printer 20, power consumption can further be suppressed, and the mode which has the higher frequency of use can be enabled earlier. In addition, since the power is ensured by the power maintaining unit 29a, the operation mode at the time at which the supply of power is stopped can be more accurately stored in the flash ROM 23. Moreover, there is a high demand for the printer to suppress power consumption, and the frequency of use immediately after starting operation is different, so that applying the invention to the printer has great significance.

In addition, the invention is not limited by the above-mentioned embodiment, and it is needless to say that various modifications can be made without departing from the spirit, and scope of the invention.

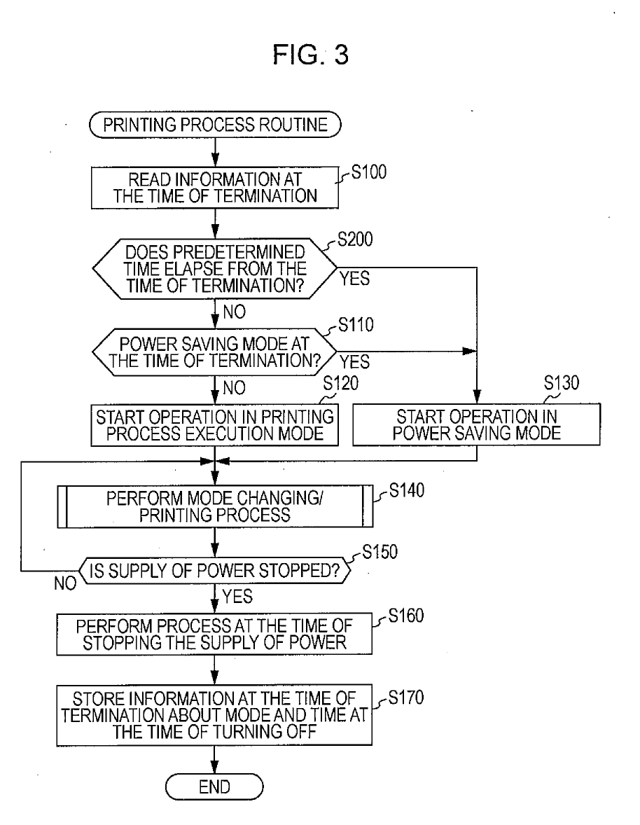

For example, in the embodiment described above, the printer starts operation in the operation mode performed at the time of termination of the previous operation. However, as illustrated in FIG. 3, an operation mode in which the operation is started may be selected on the basis of whether or not a predetermined time has elapsed from the time of termination of the previous operation. FIG. 3 is a flowchart of another example of the printing process routine. In the following description, the same processes as those of the printing process routine of FIG. 2 are denoted by the same step numbers, and a detailed description thereof will be omitted. When the routine is started, the CPU 22 reads the information at the time of termination in Step S100, calculates a difference between the current time of the RTC 27 and the time of termination of the previous operation which is stored in the information at the time of termination, and determines whether or not a predetermined time has elapsed from the time of termination of the previous operation (Step S200). The predetermined time may be determined according to, for example, the application of the printer 20, and may be, for example, a time (for example, 10 minutes or the like) to detect a momentary power failure, or a time (for example, 10 hours or the like) to detect starting operation at the time of starting operation every day. When the predetermined time elapses from the time of termination of the previous operation, it means that a relatively large amount of time has elapsed, and for example, it is determined that power is newly turned on the next day or the like. Then, a process of starting operation in the power saving mode is performed in Step S130. However, when the predetermined time has not elapsed from the time of termination of the previous operation, the CPU 22 determines that the printer has started operating again after a relatively short time due to a problem such as a momentary power failure and determines whether or not the printer 20 was in the power saving mode at the time of termination in Step S110. Then, the processes after the above-mentioned Step S110 are performed. In the case of re-starting operation after a relatively short time, the operation mode at the time of termination represents the frequency of use of the printer 20 more reliably, and the mode with higher frequency of use can be used earlier. In addition, in the case of starting operation after a relatively large amount of time, the printer 20 starts operation in the power saving mode, so that power consumption can further be suppressed.

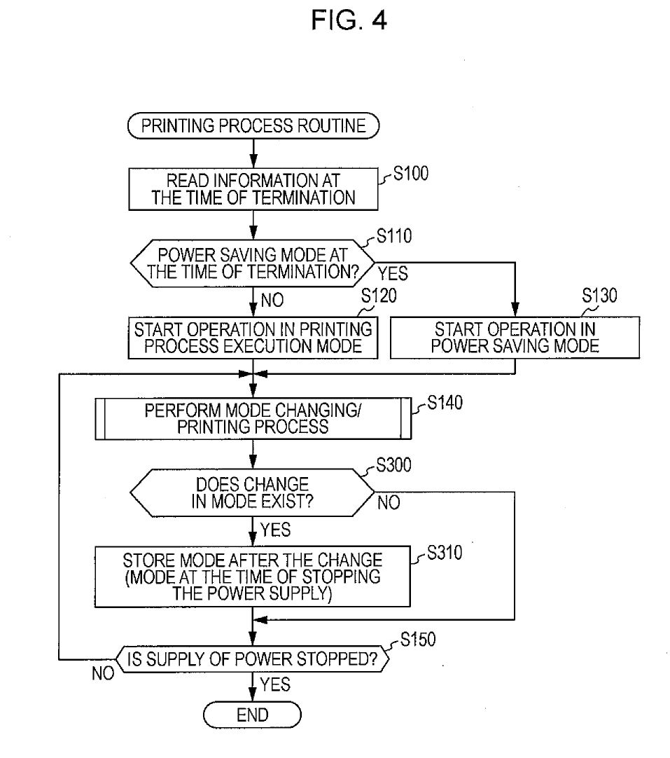

In the embodiment described above, the power maintaining unit 29a is provided, and the information at the time of termination after the supply of power is stopped is stored. However, as illustrated in FIG. 4, the operation mode at the time of termination may be stored by storing the mode after switching the mode to the mode changing/printing process of Step S140. Here, the power maintaining unit 29a may be omitted. FIG. 4 is a flowchart of another example of the printing process routine. Here, in the description, the routine is stored in the flash ROM 33 and executed by the CPU 32 of the printer 30. When the routine is started, the CPU 32 performs Steps S100 to S140 described above. That is, after starting operation in the operation mode at the time of termination of the previous operation, a printing process is performed or awaited while the operation mode is switched. When the mode changing/printing process is performed in Step S140, the CPU 32 determines whether the operating mode has been switched upon the satisfaction of a power saving switching condition or a normal switching condition (Step S300), and when the operation mode has been switched, including the operation mode after switching to be stored in the information at the time of termination is stored in the flash ROM 33 (Step S310). After Step S310, or when the operation mode is not switched in Step S300, it is determined whether or not the supply of power is stopped in Step S150 described above, when the supply of power is not stopped, the process after Step S140 is executed, and when the supply of power is stopped, this routine is terminated as it is. Likewise, the operation mode after switching the operation mode corresponds to the operation mode at the time of termination of the printer 30. Thus, the operation mode is stored in advance when the operation mode is switched, so that the power consumption can be suppressed more reliably, and the mode with higher frequency of use can be used earlier. In addition, the power maintaining unit 29a can be omitted, so that the configuration can be simplified. Otherwise, the routine may be executed by the printer 20 having the power maintaining unit 29a. Here, after determining that the supply of power is stopped in Step S150, the process of stopping the supply of power of Step S160 may be performed.

According to the embodiments described above, the information at the time of termination is stored in the flash ROM 23 or the flash ROM 33, however, the information may also be stored in, for example, HDDs, rewritable optical disks (DVDs or the like), backup RAMS, EEPROMs, and the like without limitation as long as data can be stored therein.

According to the embodiments described above, the operation mode in which the operation is started is set without distinguishing between the time of normal termination at which the power key 28a is held down and the time of termination due to problems with the supply of power, such as, a power failure, the unplugged apparatus, the cutting of the breaker 15. However, the time of normal termination or the time of termination due to problems with the supply of power may be determined, and the operation mode in which the operation is started may be set according to the determination result.

According to the embodiments described above, the printer 20 or the printer 30 is described as the electronic apparatus of this invention. However, a multi-function printer with a scanner unit for reading an image, or a FAX device which includes a scanner unit and is connected to a phone line may be employed. In addition, the printing mechanism 26 or the printing mechanism 36 is configured as a mechanism of an inkjet type or an electrophotographic type. However, a thermal transfer type or a dot impact type color printer, or monochrome printer thereof may be employed. In addition, the printing apparatus is used as the electronic apparatus. However, the electronic apparatus is not particularly limited thereto, and for example, computers such as fixed-type desktop computers and portable notebooks, image apparatuses such as televisions, videos, HDD recorders, DVD players, and photo viewers, image processing apparatuses such as digital cameras, digital videos, and scanners, communication devices such as mobile phones, fixed or portable gaming devices, and the like may be employed. Additionally, in the embodiment, the electronic apparatus is described. However, the embodiment may be applied to a method of controlling the electronic apparatus and a program for executing the method.

The entire disclosure of Japanese Patent Application No. 2008-311962, filed Dec. 8, 2008 is expressly incorporated by reference herein.

What is claimed is:

1. An electronic apparatus that selectively performs one of a plurality of operation modes including a first mode and a power saving mode with lower power consumption than the first mode, comprising:
a memory unit that stores data;
a power unit that is supplied with power; and
a control unit that stores in the memory unit the operation mode at the time at which supply of power to the power unit is stopped, and when the supply of power to the power unit is started, reads the operation mode stored in the memory unit and starts operation in the read operation mode.

2. The electronic apparatus according to claim 1, wherein the control unit stores in the memory unit the operation mode at the time at which the supply of power is stopped by storing in the memory unit the operation mode that is performed after switching the operation mode of the electronic apparatus from another mode to the power saving mode, or from the power saving mode to another mode.

3. The electronic apparatus according to claim 1, wherein the control unit determines whether or not time elapsed from the time of termination of the previous operation has passed a predetermined time when supply of power from the power unit is started, starts operation in the power saving mode when the elapsed time passes the predetermined time, and reads the operation mode stored in the memory unit when the elapsed time has not passed the predetermined time and then starts operation in the read operation mode.

4. The electronic apparatus according to claim 1,
wherein the power unit includes a power maintaining unit that maintains power when power supplied from an external power source is blocked, and
the control unit is supplied with power from the power maintaining unit when the power supplied from the external power source is cut off, and stores the operation mode in the memory unit.

5. The electronic apparatus according to claim 1, further comprising a printing process unit that is supplied with power from the power unit and prints an image on a printing medium,
wherein the control unit controls the printing process unit to perform the printing process.

6. A method of controlling an electronic apparatus that includes a memory unit for storing data and selectively performs one of a plurality of operations modes including a first mode and a power saving mode with lower power consumption than the first mode, the method comprising:
storing in the memory unit the operation mode at the time at which supply of power is stopped; and
reading the operation mode stored in the memory unit when supply of power is started, and starting operation in the read operation mode.
